(19) United States
(12) Patent Application Publication
(10) Pub. No.: US 2002/0147945 A1
(43) Pub. Date: Oct. 10, 2002

(54) Automated analysis of interface timing measurements

(75) Inventors: Travis D. Fox, Edmond, OK (US); Edwin S. Olds, Norman, OK (US); Mark A. Thiessen, Mustang, OK (US)

Correspondence Address: MERCHANT & GOULD P.C., P.O. Box 2903, Minneapolis, MN, 55402-0903, US

(73) Assignee: Seagate Technology LLC

(21) Appl. No.: 10/061,470

(22) Filed: Feb. 1, 2002

Related U.S. Application Data
(60) Provisional application No. 60/282,236, filed on Apr. 6, 2001.

(51) Int. Cl. H04L 1/22

(52) U.S. Cl. 714/47

(57) ABSTRACT

A system for evaluating whether an interface between a host device and a target device complies with specifications of an industry standard, such as, without limitation, SCSI, Serial ATA, Parallel ATA and Fibre Channel Arbitrated Loop, is disclosed. The system scans a communication trace between the host device and the target device to detect a timing measure present in the communication trace. The timing measure begins with a start condition and terminates with an ending condition. The start and ending conditions may be functions of logic transitions on either multiple or single signal lines in the communication trace. After a timing measure is detected, the system evaluates the length of the timing measure against a timing measure protocol specified by the industry standard. A computer-readable program storage device which tangibly embodies a program of instructions executable by a computer system for evaluating whether the interface complies with the industry standard is also disclosed.

### RELATED APPLICATIONS

This application claims priority of U.S. provisional application Serial No. 60/282,236, filed Apr. 6, 2001.

### FIELD OF THE INVENTION

This application relates generally to an interface between devices of a computer system and more particularly to a tool for verification of interface timing measures against an industry standard.

### BACKGROUND OF THE INVENTION

Calculation, analysis and verification of interface timing measures of a disc drive-host computer interface against an industry standard may be used in both design and product assurance phases of disc drive qualification in order to guarantee that the disc drive operates as expected over a bus interface with the host computer. Furthermore, drive manufacturers perform such processes to ensure that no conditions exist that would be detrimental to operation of the host computer or other devices coupled to the bus. Currently, disc drive manufacturers utilize the following manual process to calculate, analyze and verify interface timing measures against industry standards, such as, without limitation, Serial Advanced Technology Attachment (SATA), Parallel ATA (PATA) and Small Computer System Interface (SCSI). First, a host controller card is used to exercise the disc drive under specific conditions while a bus analyzer is used to capture the entire test stream, also referred to as a bus trace, or more generally, a communication trace. A small sample of timing measurements, also referred to as timing measures, is then manually parsed on a bus analyzer and the individual timing measures are compared to the appropriate nominal and range times of protocol measures from the applied industry standard (i.e., Serial ATA, Parallel ATA, and SCSI).

Although current drive manufacturers may calculate, analyze and verify interface timing measures against industry standards at the disc drive design level, the aforementioned manual process is generally too tedious and time-consuming to administer at the disc drive development level. That is, current drive manufacturers typically only test for design flaws, thereby ignoring the possibility that specific hardware and/or firmware components of an assembled disc drive may actually contain a manufacturing flaw. Another problem associated with the earlier-described manual process for calculating, analyzing and verifying interface timing measures against industry standards for disc drive-host computer interfaces relates to the relatively small sample of timing measures taken from the bus trace. This extreme undersampling respective of the entire population of timing measures present in the bus trace may result in incorrect determinations of whether a disc drive-host computer interface meets or fails each protocol measure of the applied industry standard. However, due to the tedious nature of this process, it is not feasible to increase the sampling of timing measures used in evaluating whether the interface complies with the industry standard.

### SUMMARY OF THE INVENTION

Against this backdrop the present invention has been developed. An embodiment of the present invention is a system for evaluating whether an interface between a host device and a target device complies with specifications of an industry standard, such as, without limitation, SCSI, Serial ATA and Parallel ATA. More specifically, the system of this embodiment utilizes a bus analyzer to scan a communication trace transmitted between the host device and the target device. The communication trace may be defined as various communications between the host device and the target device transmitted as signal lines over a bus. As such, the communication trace may include both data and control communications between the devices. The bus analyzer generates a log file from the communication trace that records logic transitions of the data and control communications in the communication trace.

This embodiment of the system of the present invention includes a timing event analysis module for detecting one or more timing measures in the communication trace and a timing measure analysis module for analyzing the detected timing measure(s) to determine whether the interface complies with the applied industry standard. More specifically, the timing event analysis module analyzes the logic transitions recorded in the log file to identify the timing measure(s) present in the communication trace. After the timing measure(s) are identified, the timing measure analysis module evaluates each timing measure against a timing measure protocol specified by the industry standard. For example, the timing measure analysis module may compare the length of each timing measure to an exemplary length specified by the timing measure protocol to determine whether the timing measure complies with a specification of the industry standard.

Embodiments of the invention may be implemented, for example, as a computer-readable program storage device which tangibly embodies a program of instructions executable by a computer system to evaluate timing measures of an interface between devices connected over a bus against an industry standard for the interface to determine whether the interface complies with the industry standard.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a functional block diagram generally showing the main functional components used to control the disc drive of FIG. 1.

FIG. 3 is a functional diagram of a trace evaluation system for evaluating a bus trace between devices communicating over a bus in accordance with an embodiment of the present invention.

FIG. 4 is a timing diagram illustrating logic transitions of signal lines of the bus trace of FIG. 3 in accordance with an exemplary embodiment of the present invention.

FIG. 5 is a flow diagram that illustrates operational processes for evaluating timing measures of a bus trace between devices communicating over a bus in accordance with an embodiment of the present invention.

FIG. 6 is a flow diagram that illustrates operational processes shown in FIG. 5 in more detail.

### DETAILED DESCRIPTION

The present invention and its various embodiments are described in detail below with reference to the figures. When referring to the figures, like structures and elements shown throughout are indicated with like reference numerals.

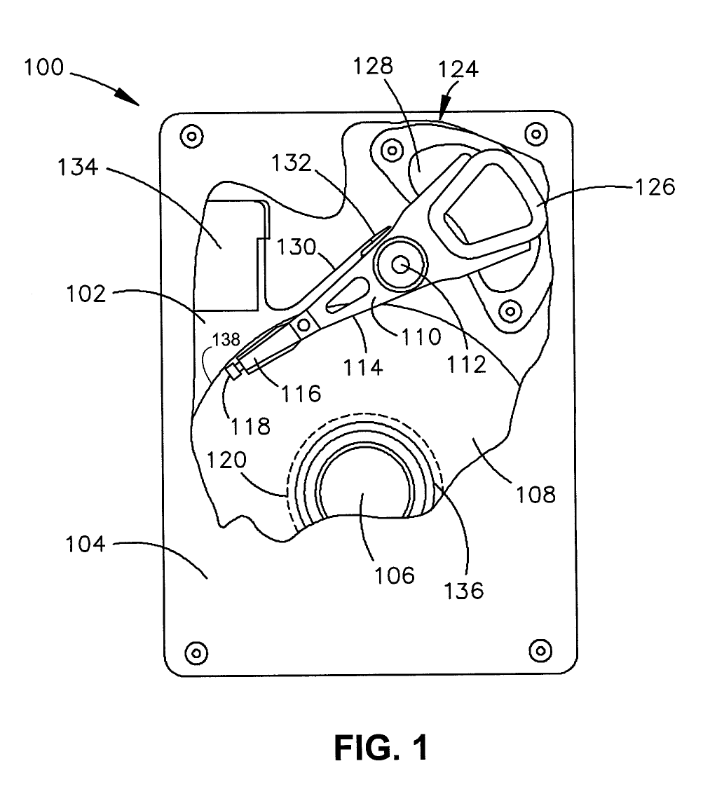

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive 100 in a conventional manner. The components include a spindle motor 106 which rotates one or more discs 108 at a constant high speed. Information is written to and read from tracks on the discs 108 through the use of an actuator assembly 110, which rotates about a bearing shaft assembly 112 positioned adjacent to the discs 108. The actuator assembly 110 includes a plurality of actuator arms 114 which extend towards the discs 108, with one or more flexures 116 extending from each of the actuator arms 114. Mounted at the distal end of each of the flexures 116 is a read/write head 118 which includes an air bearing slider enabling the read/write head 118 to fly in close proximity above the corresponding surface of the associated disc 108.

The spindle motor 106 is typically de-energized when the disc drive 100 is not in use for extended periods of time. In accordance with one embodiment of the present invention, the read/write heads 118 are moved over park, or landing, zones 120 near the inner diameter 136 of the discs 108 when the drive motor is de-energized. The read/write heads 118 may be secured over the landing zones 120 through the use of an actuator latch arrangement, which prevents inadvertent rotation of the actuator assembly 110 when the heads 118 are parked. Although the landing zone 120 is shown in FIG. 1 as located in close proximity to the inner diameter 136 of the discs 108, a landing zone 120 may also be located in close proximity to an outer diameter 138 of the discs 108. Furthermore, a landing zone 120 may be located on any portion of the discs 108 between the outer diameter 138 and the inner diameter 136 of the discs 108. Alternatively, the read/write heads 118 may be removed from the surface of the discs 108 by load/unload ramps positioned in close proximity to the outer diameter 138 when the drive motor is de-energized. As such, the read/write heads 118 may be secured by the ramps to prevent inadvertent rotation of the actuator assembly 110 when the discs 108 are spinning at a velocity insufficient to maintain an air bearing between the sliders and the discs 108. The heads 118 are maintained on the ramps in the park position through the use of an actuator latch arrangement, which prevents inadvertent rotation of the actuator arms 114 when the heads are parked. This latch arrangement is typically a magnetic latch which magnetically holds the actuator against a stop.

The radial position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112 and the heads 118 are caused to move across the surfaces of the discs 108.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and for amplifying read signals generated by the heads 118 during a read operation. The flex assembly terminates at a flex bracket 134 for communication through the base 102 to a disc drive printed circuit board (not shown) mounted to the bottom side of the disc drive 100.

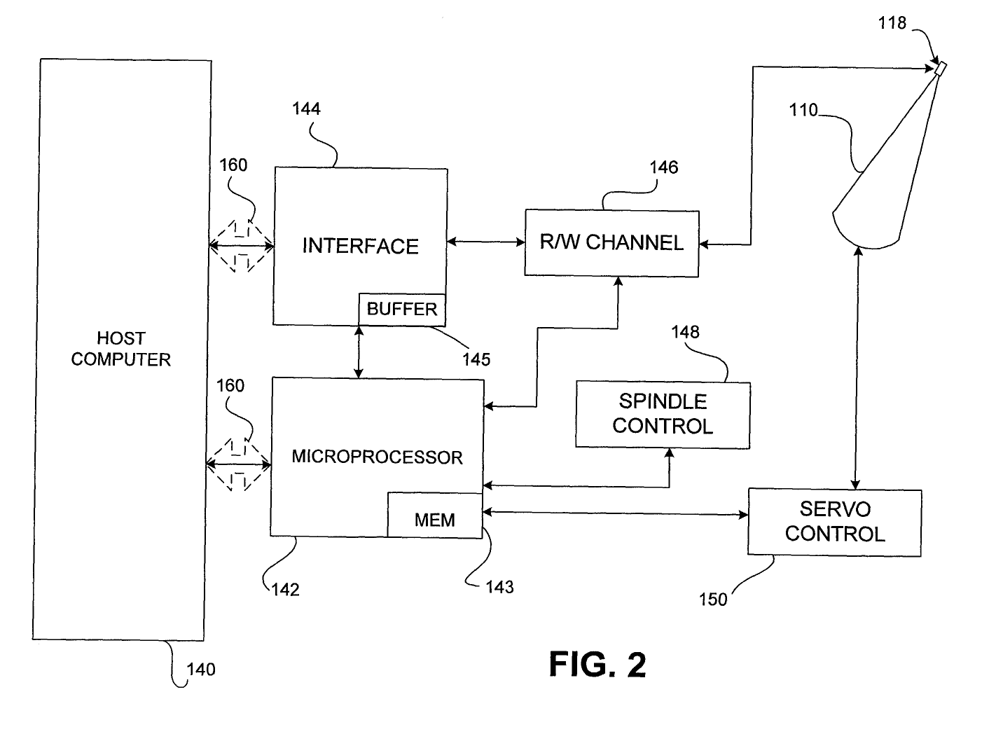

Referring now to FIG. 2, shown therein is a functional block diagram of the disc drive 100 of FIG. 1 generally showing the main functional circuits which are resident on the disc drive printed circuit board and used to control the operation of the disc drive 100. The disc drive 100 is shown in FIG. 2 to be operably connected to a host computer 140 in which the disc drive 100 is mounted in a conventional manner. Control communication paths are provided between the host computer 140 and a disc drive microprocessor 142, the microprocessor 142 generally providing top level communication and control for the disc drive 100 in conjunction with programming for the microprocessor 142 stored in microprocessor memory (MEM) 143. Specifically, the disc drive 100 communicates with the host computer 140 using a bus 160. A bus is generally defined as a path carrying data between two or more devices. The bus 160 used to communicate data and control lines between the host computer 140 and the disc drive 100 is shown in dashed arrows because the bus 160 is not in and of itself a single physical object, but rather a collection of cabling/wiring that, taken together, makes up a communication channel between the host computer 140 and the disc drive 100. As such, the bus 160 carries the cables/wires used to transfer data between a disc drive interface 144 and the host computer 140 as well as the cables/wires used to transfer data between the microprocessor 142 and the host computer 140.

The MEM 143 can include random access memory (RAM), read only memory (ROM), and other sources of resident memory for the microprocessor 142. The discs 108 are rotated at a constant high speed by a spindle control circuit 148. The radial position of the heads 118 is controlled through the application of current to a coil in the actuator assembly 110. A servo control system 150 provides such control.

Data is transferred between the host computer 140 and the disc drive 100 by way of the disc drive interface 144, which includes a buffer 145 to facilitate high speed data transfer between the host computer 140 and the disc drive 100. Data to be written to the disc drive 100 are thus passed from the host computer 140 to the buffer 145 and then to a read/write channel 146, which encodes and serializes the data and provides the requisite write current signals to the heads 118. To retrieve data that has been previously stored by the disc drive 100, read signals are generated by the heads 118 and provided to the read/write channel 146. The interface 144 performs read signal decoding, error detection, and error correction operations. The interface 144 then outputs the retrieved data to the buffer 145 for subsequent transfer to the host computer 140.

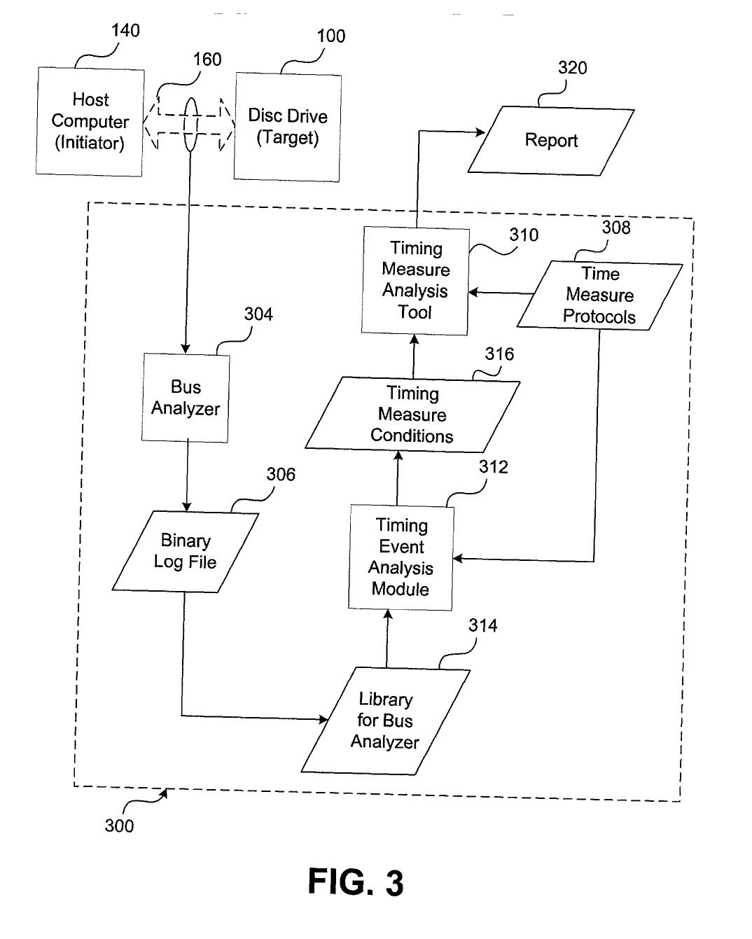

FIG. 3 shows a functional block diagram of a trace evaluation system 300 in accordance with an embodiment of the present invention. The trace evaluation system 300 monitors and analyzes communications between two devices associated with a computer system. More specifically, the trace evaluation system 300 analyzes data and control signals transmitted in a communication trace over the bus 160 to detect timing measures occurring on the trace and thereafter evaluate the timing measures against threshold parameters, or protocols, specified by an industry standard.

Communication traces between various kinds of devices may be evaluated by the trace evaluation system 300. Each device may generally be referred to as either an initiator device or a target device. The initiator device, which may also be referred to as a host, initiates communication with another device. The target device receives the initial communication from the initiator and responds. The communication trace, which includes all communications between the devices over a predefined period of time beginning with the initial communication from the initiator, may also be referred to as a bus trace due to the fact that the communications are transmitted between devices using the bus 160. In the exemplary embodiment of the present invention shown in FIG. 3, the initiator is a host computer 140 and the target is a disc drive 100. The disc drive 100 and the host computer 140 are operably connected, and thus control and data signal lines are transferred between the drive 100 and the host computer 140, using the bus 160.

Various industry standards provide specifications governing the transfer of data over a bus 160, including, without limitation, Serial Advanced Technology Attachment (SATA), Parallel ATA (PATA), Fibre Channel Arbitrated Loop (FC-AL) and Small Computer System Interface (SCSI). The aforementioned industry standards generally provide protocols specifying the occurrence and length of timing measures occurring on communications transmitted over a bus 160. In accordance with one embodiment, and not by means of limitation, the industry standard described herein comprises a SCSI specification, and therefore, the timing measure protocols used by the trace evaluation system 300 are SCSI protocols. The SCSI standard, as well as the other industry standards noted above, is widely known and therefore not described in detail herein.

The host computer 140 is shown communicating with the disc drive 100 using the bus 160. As such, the trace evaluation system 300 monitors and analyzes various communications between the host computer 140 and the disc drive 100 on the bus 160. As noted above, the communications are preferably contained in a selected communication trace bounded by an initial communication and an ending, or final, communication. Because the communications are described below as being transmitted over the bus 160, as noted above, the communication trace is hereinafter referred to as a bus trace. In accordance with an embodiment, the bus trace may comprise test communications transmitted between the host computer 140 and the disc drive 100 during disc drive design and development. As such, the trace evaluation system 300 may be used in this situation to detect design flaws in the disc drive model being tested. In accordance with another embodiment, the bus trace may comprise test communications transmitted between the host computer 140 and the disc drive 100 following disc drive assembly, possibly while the drive 100 is currently on the manufacturing line. As such, the trace evaluation system 300 may be used in this situation to detect manufacturing flaws in the specific disc drive 100 being tested. In accordance with yet another embodiment, the bus trace may comprise communications transmitted between a host computer 140 and a disc drive 100 during operation of the disc drive 100 following delivery of the drive 100 to a customer. As such, the trace evaluation system 300 may be used in this situation to detect run-time or operational errors in the disc drive 100 outside of the design, development or manufacturing environment.

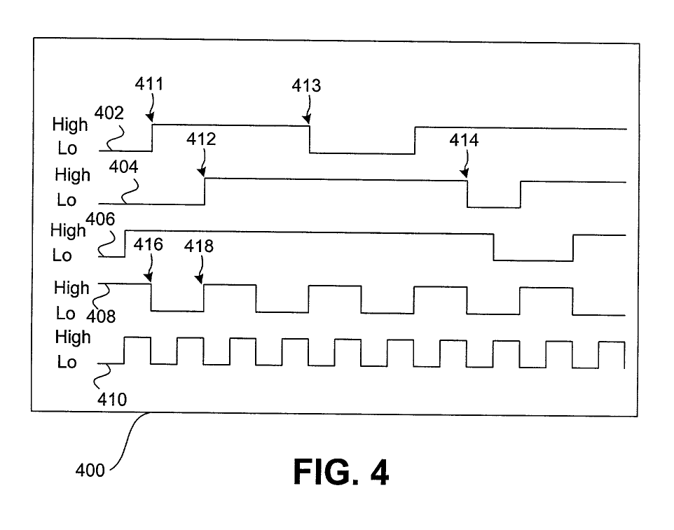

The trace evaluation system 300 preferably includes a bus analyzer 304, a timing event analysis module 312 utilizing a bus analyzer library 314, and a timing measure analysis tool 310. The bus analyzer 304 monitors the communications between the host computer 140 and the disc drive 100 to output a binary log file 306 indicative of logic transitions in communications being transmitted over the bus 160. The communications are preferably transmitted over the bus 160 in the form of signal lines, such as data lines and control lines, contained within each communication trace. FIG. 4, described below, illustrates in more detail exemplary signal lines that may be included in such communications between the drive 100 and the host computer 140.

The binary log file 306 is input to the timing event analysis module 312. The timing event analysis module is preferably a software module, i.e., a dynamic link library (DLL) or a stand-alone executable program (EXE), that reads the binary log file 306 to identify predefined timing events 316 in the bus trace. A timing event is preferably defined as a transition in logic state, e.g., low to high or high to low, of any single signal line of the bus trace. Thus, the term “timing event” is used herein to define a single logic transition occurring in the bus trace between two devices. Specifically, the timing event analysis module 312 scans each signal line in the bus trace, and more specifically, each timing event, to identify timing measure conditions specified by the applied industry standard. The timing measure conditions correspond to appropriate start and ending conditions for timing measures in the bus trace. A timing measure is preferably defined as the amount of time between one defined state occurring on a communication trace, i.e., the bus trace in accordance with this embodiment, to another defined state. As such, each timing measure has an associated type, regardless of the industry standard applied to the measure. Any number of timing measures of a particular type may exist in a bus trace. Indeed, a bus trace may include only one timing measure of a particular type.

The timing measure conditions direct the timing event analysis module 312 to identify specific timing events in the bus trace that either singly or in combination with other timing events represent either a beginning or an ending boundary for the timing measure. A timing measure condition may be a function of either multiple timing events or a single timing event. For example, one timing measure condition associated with a specific timing measure type for the host-drive interface may be defined as a change in transition state of multiple signal lines, whereas another timing measure condition associated with a separate timing measure type for the host-drive interface may be defined by a change in transition of a single signal line. Based on the type of bus analyzer 304 utilized, a bus analyzer library 314 may be used to enable scanning of the binary log file 306 by the timing event analysis module 312. The bus analyzer library 314 is a set of functions compiled into the timing event analysis module 312 that allows the module 312 to access the data contained in the binary log file 306. As such, the binary log file 306 is shown in FIG. 3 being input to the timing event analysis module 312 via the bus analyzer library 314.

The timing event analysis module 312 reads the time stamp for each identified start and ending condition and thereafter outputs this information to the timing measure analysis tool 310 in a format such that the timing measure analysis tool 310 may evaluate occurrence of the timing measure condition 316 and length, in time, of the timing measure to which the timing event 316 is associated. The timing measure analysis tool 310 then matches each start condition with an associated ending condition based on the type associated with each timing measure. That is, the timing measure analysis tool 310 identifies the timing measures on the bus trace by matching each start condition with a corresponding ending condition. The timing measure analysis tool 310 then calculates the time differences between corresponding starting and ending conditions associated with each timing measure to determine the length, in time, of each timing measure. The timing measure analysis tool 310 also performs various statistical analyses on the calculated timing measures, including, without limitation, determining an average length, in time, of all timing measures of a particular type. The timing measure analysis tool 310 compares the average length, in time, associated with each particular timing measure type to timing measure protocols 308 specified by the applied industry standard. Based on these comparisons, the timing measure analysis tool 310 generates a report 320 illustrating whether and to what degree the host-drive interface conforms, or follows, the applied specification.

Referring now to FIG. 4, shown therein is a timing diagram illustrating an exemplary representation of signal lines (402, 404, 406, 408, 410) contained in a bus trace 400 of communications being transmitted between devices over a bus 160 in accordance with an embodiment of the present invention. The timing diagram is shown in FIG. 4 and described below to briefly illustrate the concept of timing measures, timing events, and timing measure conditions occurring on signal lines (402, 404, 406, 408, 410) in the bus trace 400. As such, it should be appreciated that the timing diagram is but one representation of specific timing measures, timing events, and timing measure conditions occurring on a bus trace 400 between devices. Indeed, depending on the communications being exchanged between devices, a bus trace 400 may comprise any number of signal lines, and thus, construction of the terms “timing measures,” “timing events,” and “timing measure conditions” should not be limited to encompass only the exemplary signal lines (402, 404, 406, 408, 410) included in the bus trace 400. Likewise, signal lines may carry information associated with any form of content transmitted between devices. As noted above, although the devices are described below as a host computer 140 and a disc drive 100, it should be appreciated that the devices may be any type of device communicating over a bus 160.

The timing diagram 400 includes a first signal line 402, a second signal line 404, a third signal line 406, a fourth signal line 408 and a fifth signal line 410. Each signal line 402, 404, 406, 408 and 410 reveals various timing events defined as transition points in time wherein the logic states of the signal lines 402, 404, 406, 408 and 410 toggle from logic high to logic low, or vice-versa. That is, the timing events are shown in FIG. 4 as changes in logic, either from high to low or from low to high, occurring on each of the exemplary signal lines 402, 404, 406, 408 and 410. A timing measure is preferably defined by starting and ending timing measure conditions, which, as noted above and described below, may be a function of timing events on either multiple signal lines 402, 404, 406, 408 and 410 or a single signal line, i.e., 402, 404, 406, 408 and 410. As an example of a timing measure having conditions that are functions of timing events on multiple signal lines, a start condition may be specifically defined to occur following occurrence of a timing event on both the second (404) and the first (402) signal lines. That is, the start condition occurs at the first-occurring timing event 412 on the second signal line 404 because a timing event 411 has already occurred on the first signal line 402. As described with the start condition, the ending condition for this exemplary timing measure may also be defined as a function of timing events occurring on multiple signal lines 402, 404, 406, 408 and 410. For example, the ending condition may be specifically defined to occur following occurrence of subsequent timing events on both the second (404) and the first (402) signal lines. That is, the ending condition occurs at the second timing event 414 on the second signal line 404 because at least one timing event 413 has already occurred on the first signal line 402. As such, the timing measure for this set of start and ending conditions begins at the first timing event 412, in time, occurring on the second signal line 404 and terminates at the second timing event 414, in time, occurring on the second signal line 404.

To illustrate a timing measure having conditions that are functions of timing events on a single signal lines, a start condition may be specifically defined at the first timing event 416 on the fourth signal line 408 and every other timing event thereafter, wherein each start condition is succeeded by an ending condition. As such, the first-occurring timing measure on the fourth signal line 408 begins at the first timing event 416, in time, and concludes at the next timing event 418, in time, occurring on the fourth signal line 408.

Embodiments of the present invention may also be implemented as a computer-readable program storage device which tangibly embodies a program of instructions executable by a computer system for evaluating timing measures of an interface between devices against an industry standard for the interface. As such, the logical operations of the various embodiments of the present invention may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

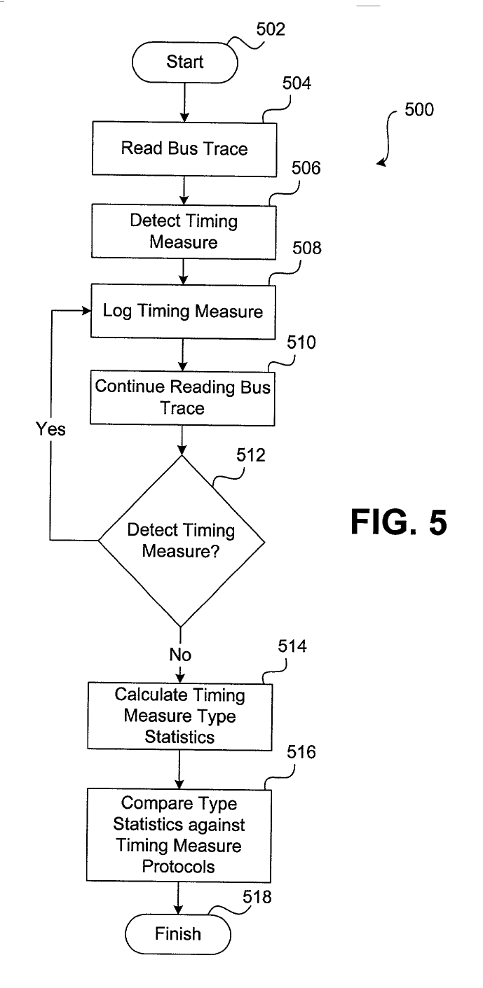

Referring now to FIG. 5, a flow diagram illustrating operations of an evaluation process 500 for evaluating timing measures of an interface between devices against an industry standard for the interface is shown in accordance with an embodiment of the present invention. Specifically, the evaluation process 500 monitors a communication trace between a host device, such as the host computer 140, and a target device, such as the disc drive 100, to detect and thereafter analyze timing measures occurring on the trace. Because the communications are described below as being transmitted over the bus 160, as noted above, the communication trace is hereinafter referred to as a bus trace, such as the bus trace 400 shown in FIG. 4. The evaluation process 500 may be utilized to evaluate multiple timing measure types occurring on the bus trace between the devices. However, for illustrative and claritive purposes, the evaluation process 500 is described below as evaluating a single timing measure type against a timing measure protocol specified by the industry standard. It should be appreciated that the evaluation process 500 may be implemented or performed multiple times, sequentially or simultaneously, to evaluate multiple timing measure types against multiple timing measure protocols specified by an industry standard.

Although the evaluation process 500 is described below as evaluating timing measures on a bus trace between a host computer 140 and a disc drive 100, the evaluation process may be used to evaluate timing measures on a trace between any two devices that communicate using a bus 160. The evaluation process 500 comprises an operation flow beginning with a start operation 502 and concluding with a terminate operation 518. From the start operation 502, the operation flow passes to a read operation 504. The read operation 504 reads the bus trace between the host computer 140 and the disc drive 100 to identify timing measures of a particular type. In accordance with a preferred embodiment, the read operation 504 scans a binary log file, such as the binary log file 306 shown in FIG. 3, generated by a bus analyzer 304 and representing the logic state transitions of signal lines in the bus trace. The read operation 504 continues reading the bus trace until a timing measure is detected in the trace by the detect operation 506.

The detect operation 506 identifies the timing measure in the bus trace based on timing measure conditions associated with a timing measure protocol specified by the applied industry standard, i.e., Serial ATA, Parallel ATA or SCSI. More specifically, the detect operation 506 first detects a start condition identifying the beginning of the timing measure. After the detect operation 506 detects the start condition, the detect operation 506 searches for and thereafter detects an ending condition for the timing measure. That is, by locating the ending condition, the detect operation 506 identifies the timing measure, which, as described above, begins at the start condition and terminates at the ending condition. As noted above, start and ending conditions may be a function of one or more timing events on either multiple signal lines or a single signal line. Once the timing measure is detected, the operation flow passes to a log operation 508.

The log operation 508 stores information associated with the timing measure in memory. In accordance with an exemplary embodiment, the log operation 508 may store information identifying the length, in time, from the start condition to the ending condition, thereby storing the magnitude, in length, of the timing measure identified by the detect operation 506. The log operation 508 may also time-stamp the start and ending conditions of the timing measure and thereafter store the time stamp with the information identifying the magnitude of the timing measure. The memory to which the aforementioned information is stored may be volatile (such as RAM), non-volatile (such as ROM, flash memory, etc.) or some combination of the two. From the log operation 508, the operation flow passes to a second read operation 510.

The second read operation 510 continues reading the bus trace between the host computer 140 and the disc drive 100 to identify subsequent timing measures of the type being detected by the evaluation process 500. The second read operation 510 reads the bus trace until a query operation 512 detects either a subsequent timing measure or the end of the bus trace being evaluated. If the query operation 512 detects a subsequent timing measure, the operation flow returns to the log operation 508. The log operation 508 logs each subsequently-occurring timing measure to memory and operation flow continues as previously described. If, however, no subsequent timing measures are detected, the end of the bus trace is assumed by the query operation 512 and operation flow passes to a calculate operation 514.

The calculate operation 514 statistically analyzes each timing measure detected on the bus trace by the detect operation 506 and logged to the memory by the log operation 508 to render a representative timing measure for the timing measure type being evaluated by the trace evaluation process 500. From the calculate operation 514, the operation flow passes to an analysis operation 516. The analysis operation 516 evaluates the representative timing measure against an industry standard specification for the host-drive interface. That is, the analysis operation 516 preferably compares the representative timing measure to a timing measure protocol specified by the industry standard to determine whether the host-drive interface conforms to the applied industry standard. From the analysis operation 516, the operation flow concludes with the termination operation 518.

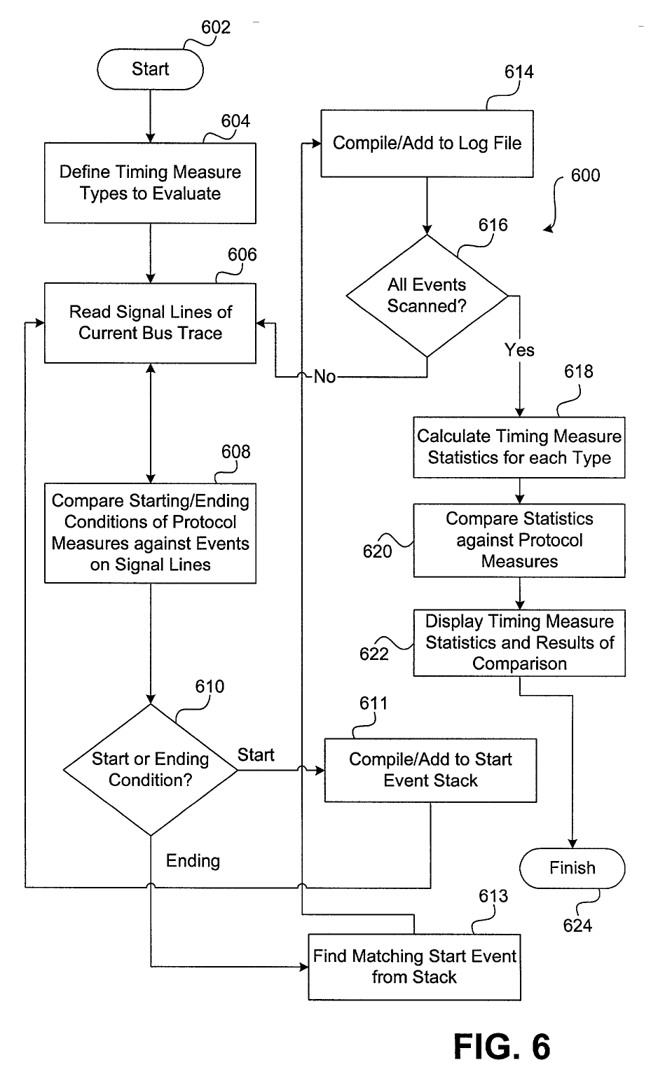

FIG. 6 is an evaluation process 600 more particularly illustrating operations shown in the evaluation process 500 in accordance with an embodiment of the present invention. Specifically, the evaluation process 600 preferably detects, records and thereafter evaluates timing measures of multiple types during a single pass, or scan, of a bus trace occurring over a bus 160 providing communication paths between at least two devices associated with a computer system. In accordance with an exemplary embodiment, the devices are hereinafter described as a host computer 140 and a disc drive 100. It should be appreciated that the evaluation process 600 may be used in conjunction with any type of bus 160 connecting any two devices, and therefore the present invention should not be construed as limited to evaluation of a bus trace between a host computer 140 and a disc drive 100. The evaluation process 600 shown in FIG. 6 comprises an operation flow beginning with a start operation 602 and concluding with a terminate operation 624. From the start operation 602, the operation flow passes to a define operation 604.

The define operation 604 defines which timing measure types are to be evaluated against an industry standard. For example, if the two devices are connected using a SCSI bus, several exemplary signal lines may be “Busy,” “Select,” and “Acknowledge.” As such, a timing measure type may be defined as a time in which all three exemplary lines have a logic state reading of high. Thus, the timing measure type in this example has a start condition occurring at a time when all three signal lines go high and an ending condition occurring at a time when only one of the signal lines goes low. Typically, a bus trace comprises multiple timing measures of each timing measure type. However, it is possible for a bus trace to include only a single timing measure of a particular type. In accordance with an embodiment, the define operation 604 includes receiving instructions from a user identifying which types of timing measures are to be detected, recorded and evaluated using the evaluation method 600. Following the define operation 604, the operation flow passes to a read operation 606.

The read operation 606 reads the bus trace transmitted between the host computer 140 and the disc drive 100 to identify timing measures of the types defined by the define operation 604. In accordance with a preferred embodiment, the read operation 606 scans a binary log file generated by a bus analyzer 304 and representing the logic state transitions of signal lines in the bus trace. The read operation 606 continues reading the bus trace until a timing measure condition is detected by the detect operation 608. As shown using a double arrow, the operation flow repeatedly passes between the read operation 606 and the detect operation 608 until a timing measure condition is detected.

The detect operation 608 detects each timing measure condition, whether start condition or ending condition, by comparing timing measure conditions of protocol timing measures specified by the industry standard against timing events on the signal lines of the bus trace being scanned. As noted above, a timing measure condition may be a function of one or more timing events occurring either on multiple signal lines or on a single signal line. For illustrative purposes, and not by means of limitation, timing measure conditions are described below as being functions of timing events occurring on multiple signal lines. As such, using the example illustrated above, a start condition may be defined as the logic state of the “Busy,” “Select,” and “Acknowledge” signal lines all read high. After the detect operation 608 detects a timing measure condition, the operation flow passes to a first query operation 610.

The first query operation 610 determines whether the detected timing measure condition is a start condition or an ending condition. If the timing measure condition is a start condition, the operation flow passes to a first compile operation 611. The first compile operation 611 first time stamps the start condition, as referenced from the beginning of the bus trace, and thereafter adds the time stamp, along with information identifying the timing measure type associated with the start condition, to a start condition stack in memory. The start condition stack contains a record of all start conditions occurring on the bus trace which have not been matched to an ending condition and thereafter logged into memory. Following the first compile operation 611, the operation flow returns to the read operation 606 and thereafter continues as previously described.

If, however, the first query operation 610 determines that the timing measure condition is an ending condition, the operation flow passes to a match operation 613. The match operation 613 first time stamps the time at which the ending condition occurs, as referenced from the beginning of the bus trace, and thereafter matches the detected ending condition to an associated start condition recorded in the start condition stack. Because a timing measure of a particular type may only occur once at a time, the match operation 613 matches each detected ending condition to a start condition based on the timing measure type of the ending condition. That is, in order for an ending condition of a particular type to occur, there must presently exist a single start condition in the start condition stack that is associated with the same timing measure type. After the ending condition is matched to an associated start condition by the match operation 613, the operation flow passes to a second compile operation 614.

The second compile operation 614 retrieves the matched pair of timing measure conditions and adds the matched pair to a log file of matched pairs for all timing measure types. The second compile operation 614 records the time stamp for each timing measure condition such that each matched pair is represented with a time stamp identifying the time of the start condition and a time stamp identifying the time of the ending condition. The absolute difference in the time stamps for the timing measure conditions of each matched pair is equal to the length, or magnitude in time, of the timing measure starting at the start condition and terminating at the ending condition. As such, the absolute difference between the magnitudes, or values, of the time stamps of each matched pair is recorded in the log file and categorized as a timing measure for a particular type. From the second compile operation 614, the operation flow passes to a second query operation 616.

The second query operation 616 determines whether all timing events of the signal lines in the bus trace have been scanned by the read operation 606 and therefore analyzed by the detect operation 608 to determine whether any more timing measure conditions exist in the bus trace. If the second query operation 616 determines that more timing events exist in the bus trace, the operation flow returns to the read operation 606 and continues as previously described. If, however, all timing events present in the bus trace have been scanned, the operation flow passes to a calculate operation 618.

The calculate operation 618 utilizes the log file to calculate statistics associated with each timing measure detected in the bus trace as well as statistics for each timing measure type defined by the define operation 602. As such, the calculate operation 618 preferably calculates the length, in time, of each timing measure and a representative timing measure for each type. The representative timing measure is preferably defined as the average length, in time, of all timing measures in a bus trace of a particular timing measure type. The calculate operation 618 may also calculate various other statistics associated with timing measures that are not discussed in detail herein, such as, without limitation, distributions of timing measures and other more advanced statistical measures. Following the calculate operation 618, the operation flow passes to an analysis operation 620.

The analysis operation 620 evaluates the representative timing measures of the timing measure types against an industry standard specification for the host-drive interface. That is, the analysis operation 620 preferably compares each representative timing measure to a timing measure protocol specified by the industry standard to determine whether the host-drive interface conforms to the industry standard. The timing measure protocol thus defines a minimum or maximum absolute value for the length, in time, of a particular timing measure. As such, a timing measure protocol may exist for each timing measure type defined by the define operation 602. Furthermore, the analysis operation 620 may individually compare each timing measure of a particular type to the timing measure protocol specified by the applied industry standard for that particular timing measure type. As such, if a single timing measure does not meet the specifications required by the industry standard, the analysis operation 620 will identify that individual timing measure as not complying with the industry standard, regardless of whether an average of all timing measures of that particular type complies with the specification. Following the analysis operation 620, the operation flow passes to a display operation 622.

The display operation 622 outputs the results of the analysis operation 620 in the form of a report, such as the report 320, detailing whether and to what extent any of the representative timing measures, or in accordance with an alternative embodiment, any of the timing measures detected in the bus trace, fail to comply with the applied industry standard. As such, the report 320 preferably includes a comparison of each timing measure statistic to an associated protocol specified by the industry standard. The report 320 may also include the time stamps of the timing measure conditions, both start and ending, as well as the length, in time, associated with each timing measure detected in the bus trace. Following the display operation 622, the operation flow concludes with the termination operation 624.

In summary, the present invention may be viewed as a system (such as 300) for evaluating whether an interface between a host device (such as 140) and a target device (such as 100) complies with specifications of an industry standard. In accordance with a preferred embodiment, the system includes a bus analyzer (such as 304) operable to scan a communication trace (such as 400) transmitted over a bus (such as 160) operably connected between the host device and the target device and record logic transitions (such as such as 411, 412, 413, 414, 416 and 418) of signal lines (such as 402, 404, 406, 408 and 410) contained in the communication trace. A timing event analysis module (such as 312) is preferably connected to the bus analyzer to analyze the logic transitions to identify a timing measure present in the communication trace. A timing measure analysis module (such as 310) is connected to the timing event analysis module to evaluate the timing measure against a timing measure protocol (such as 308) specified by the industry standard. The timing event analysis module may identify the timing measure by detecting a predetermined timing measure condition (such as 316) in the communication trace, the timing measure condition being predefined by the timing measure protocol. As such, the timing measure condition may be detected in the communication trace following occurrence of a plurality of logic transitions (such as 411 and 412), wherein each logic transition occurs on a separate signal line (such as 402 and 404). Alternatively, the timing measure condition may be detected in the communication trace following occurrence of a logic transition (such as 416) on a single signal line (such as 408).

In accordance with a more specific embodiment, the timing measure analysis module may calculate a length, in time, from a start condition (such as timing event 412) to an ending condition (such as timing event 414) and thereafter compares the length to an exemplary length specified by the timing measure protocol to determine whether the timing measure complies with a specification of the industry standard. The timing measure analysis module may also create a report (such as 320) detailing whether the timing measure complies with the protocol specified by the industry standard. The industry standard providing specifications for the interface between the devices may be Small Computer System Interface (SCSI) or Fibre Channel Arbitrated Loop. If the host device is a host computer and the target device is a disc drive, the industry standard may be Serial Advanced Technology Attachment (SATA).

In accordance with another embodiment, the present invention may be viewed as a computer-readable program storage device which tangibly embodies a program of instructions executable by a computer system to perform a method (such as in operation 500) for evaluating whether an interface between a host device (such as 140) and a target device (such as 100) complies with an industry standard. The method of this embodiment preferably includes a step of scanning (such as in operation 502) a communication trace (such as 400) transmitted between the host device and the target device, a step of identifying (such as in operation 506) a timing measure present in the communication trace and step of evaluating (such as in operation 516) the timing measure against a timing measure protocol (such as 308) specified by the industry standard. The identifying step (such as in operation 506) may include steps of detecting (such as in operation 616) logic transitions (such as 411, 412, 413, 414, 416 and 418) of signals lines (such as 402, 404, 406, 408 and 410) contained in the communication trace and analyzing (such as in operation 608) the logic transitions to identify the timing measure. More specifically, the analyzing step (such as in operation 608) may include a step of detecting (such as in operation 610) a timing measure condition (such as 316) in the communication trace, wherein the timing measure condition is predefined by the timing measure protocol. The timing measure condition may be identified by the detecting step following occurrence of a plurality of logic transitions, wherein each logic transition occurs on a separate signal line. Alternatively, the timing measure condition may be identified by the detecting step following occurrence of a logic transition on a single signal line.

In accordance with an embodiment, the evaluating step (such as in operation 516) may calculate (such as in operation 618) a length, in time, from a start condition (such as timing event 412) to an ending condition (such as timing event 414) and thereafter compare (such as in operation 620) the length to an exemplary length specified by the timing measure protocol to determine whether the timing measure complies with the a specification of the industry standard. The method may include a step of creating (such as in operation 622) a report (such as 320) detailing whether the timing measure complies with a specification of the industry standard based on evaluation of the timing measure against the timing measure protocol.

The method may further include a step of defining (such as in operation 604) a specific timing measure type having a plurality of timing measures present in the communication trace. As such, the identifying step (such as in operation 506) may detect each of the plurality of timing measures in the communication trace and the evaluating step (such as in operation 516) may calculate (such as in operation 618) a length, in time, of each of the plurality of timing measures and thereafter average the length of the plurality of timing measures to render a representative timing measure length. Finally, the evaluating step (such as in operation 516) may compare (such as in operation 620) the representative timing measure length to an exemplary length specified by the timing measure protocol. Alternatively, the method may further include a step of defining (such as in operation 604) a plurality of timing measure types, rather than a single timing measure type. As such, the evaluating step (such as in operation 516) may evaluate (such as in operation 620) the one or more timing measures associated with each timing measure type against a timing measure protocol specified by the industry standard as specific to each timing measure type. More specifically, the evaluating step (such as in operation 516) may calculate (such as in operation 618) a length, in time, of the one or more timing measures associated with each timing measure type, average (such as in operation 618) the length of the one or more timing measures associated with each timing measure type to render a representative timing measure length for each timing measure type and compare (such as in operation 620) the representative timing measure length for each timing measure type to an exemplary length specified by a timing measure protocol defined by the industry standard as specific to each timing measure type.

In accordance with yet another embodiment, the present invention may be viewed as a system (such as 300) for evaluating whether an interface between a host device (such as 140) and a target device (such as 100) complies with an industry standard, wherein a bus analyzer (such as 304) scans a communication trace (such as 400) transmitted between the host device and the target device and creates a log file (such as 306) recording logic transitions (such as 411, 412, 413, 414, 416 and 418) of signals lines (such as 402, 404, 406, 408 and 410) contained in the communication trace. The system may include a timing event analysis module (such as 312) analyzing the logic transitions to identify a timing measure present in the communication trace and a means for evaluating (such as 310; such as in operation 516) the timing measure against a timing measure protocol (such as 320) specified by the industry standard.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the device connected to and communicating with the host computer 140 via the bus 160 may be any type of device utilized by a computing environment, and not just a disc drive 100, as described in detail herein. As such, the host computer 140 may be connected via the bus 160 to any of the following devices, and thus, the trace evaluation system 300 and the trace evaluation process 500 may be utilized to evaluate timing measures of the bus trace between the host computer 140 and the following devices: any type of storage device, such as, without limitation, removable media disc drives, tape drives, quarter-inch cartridge tapes, digital audio tapes, 8 mm tapes, digital linear tapes, optical disc drives, magneto-optical drives, write once read many drives, CD-ROM drives, CD-ROM recorders and DVD-ROM recorders, DVD-RAM, CompactFlash, scanners, bar code readers, printers and any other peripherals that may be connected to a host computers between which data and control communications may occur. Moreover, the host computer 140 may be replaced by any of the aforementioned devices such that neither device connected to the bus 160 is a host computer 140 or a disc drive 100. Furthermore, the information included on the report generated by the display operation 622 may be uploaded to a result database, wherein statistics of the timing measures and comparisons of the timing measures to the protocols maybe maintained on a product and firmware basis. With particular reference to the define operation 602, the evaluation process may be scripted and even further automated in some fashion such that no user intervention is required. Moreover, a further level of artificial intelligence may be incorporated into the evaluation process to identify and measure anomalous timing measures that, although not defined by the applied industry standard, may be so substantially different from other timing measures that the measures indeed warrant evaluation. Likewise, a timing measure may be defined only using a single timing measure condition, and not a pair of conditions, as described herein. Numerous other changes may be made which will readily suggest themselves to those skilled in the art and which are encompassed in the spirit of the invention disclosed and as defined in the appended claims.

What is claimed is:

1. A system for evaluating whether an interface between a host device and a target device complies with specifications of an industry standard, the system comprising:
a bus analyzer operable to scan a communication trace transmitted between the host device and the target device and record logic transitions of signal lines contained in the communication trace;
a timing event analysis module connected to the bus analyzer to analyze the logic transitions to identify a timing measure present in the communication trace; and
a timing measure analysis module connected to the timing event analysis module to evaluate the timing measure against a timing measure protocol specified by the industry standard.

2. The system of claim 1, wherein the timing event analysis module identifies the timing measure by detecting a predetermined timing measure condition in the communication trace, the timing measure condition being predefined by the timing measure protocol.

3. The system of claim 2, wherein the timing measure condition is detected in the communication trace following occurrence of a plurality of logic transitions, wherein each logic transition occurs on a separate signal line.

4. The system of claim 2, wherein the timing measure condition is detected in the communication trace following occurrence of a logic transition on a single signal line.

5. The system of claim 2, wherein the timing measure analysis module calculates a length, in time, from a start condition to an ending condition and thereafter compares the length to an exemplary length specified by the timing measure protocol to determine whether the timing measure complies with a specification of the industry standard.

6. The system of claim 1, wherein the industry standard is Small Computer System Interface.

7. The system of claim 1, wherein the timing measure analysis module creates a report detailing whether the timing measure complies with the protocol specified by the industry standard.

8. The system of claim 1, wherein the host device is a host computer and the target device is a disc drive.

9. The system of claim 8, wherein the industry standard is Serial Advanced Technology Attachment.

10. The system of claim 1, wherein the industry standard is Fibre Channel Arbitrated Loop.

11. A program storage device readable by a computer system tangibly embodying a program of instructions executable by the computer system to perform a method for evaluating whether an interface between a host device and a target device complies with an industry standard, the method comprising steps of:
(a) scanning a communication trace transmitted between the host device and the target device;
(b) identifying a timing measure present in the communication trace; and
(c) evaluating the timing measure against a timing measure protocol specified by the industry standard.

12. A program storage device as defined in claim 11, wherein the identifying step (b) comprises steps of:
(b)(i) detecting one or more logic transitions of signals lines contained in the communication trace; and
(b)(ii) analyzing the one or more logic transitions to identify the timing measure.

13. A program storage device as defined in claim 12, wherein the analyzing step (b)(ii) comprises a step of:
(b)(ii)(A) detecting a timing measure condition in the communication trace, the timing measure condition being predefined by the timing measure protocol.

14. A program storage device as defined in claim 13, wherein the detecting step (b)(ii)(A) comprises a step of:
identifying the timing measure condition in the communication trace following occurrence of a plurality of logic transitions, wherein each logic transition occurs on a separate signal line.

15. A program storage device as defined in claim 13, wherein the detecting step (b)(ii)(A) comprises a step of:
identifying the timing measure condition in the communication trace following occurrence of a logic transition on a single signal line.

16. A program storage device as defined in claim 13, wherein the evaluating step (c) comprises steps of:
(c)(i) calculating a length, in time, from a start condition to an ending condition; and
(c)(ii) comparing the length to an exemplary length specified by the timing measure protocol to determine whether the timing measure complies with a specification of the industry standard.

17. A program storage device as defined in claim 11, wherein the industry standard is Small Computer System Interface.

18. A program storage device as defined in claim 11, wherein the method further comprises a step of:
(d) creating a report detailing whether the timing measure complies with a specification of the industry standard based on evaluation of the timing measure against the timing measure protocol.

19. A program storage device as defined in claim 11, wherein the host device is a host computer and the target device is a disc drive.

20. A program storage device as defined in claim 19, wherein the industry standard is Serial Advanced Technology Attachment.

21. A program storage device as defined in claim 11, wherein the method further comprises a step of defining a specific timing measure type having a plurality of timing measures present in the communication trace, wherein the identifying step (b) comprises a step of:
detecting each of the plurality of timing measures in the communication trace.

22. A program storage device as defined in claim 21, wherein the evaluating step (c) comprises a step of:
(c)(i) calculating a length, in time, of each of the plurality of timing measures;
(c)(ii) averaging the length of the plurality of timing measures to render a representative timing measure length; and
(c)(iii) comparing the representative timing measure length to an exemplary length specified by the timing measure protocol.

23. A program storage device as defined in claim 11, wherein the method further comprises a step of defining a plurality of timing measure types, wherein each timing measure type is associated with one or more timing measures present in the communication trace and the identifying step (b) comprises a step of:
detecting the one or more timing measures present in the communication trace associated with each timing measure type.

24. A program storage device as defined in claim 23, wherein the evaluating step (c) comprises a step of:
evaluating the one or more timing measures associated with each timing measure type against a timing measure protocol specified by the industry standard as specific to each timing measure type.

25. A program storage device as defined in claim 23, wherein the evaluating step (c) comprises steps of:
(c)(i) calculating a length, in time, of the one or more timing measures associated with each timing measure type;
(c)(ii) averaging the length of the one or more timing measures associated with each timing measure type to render a representative timing measure length for each timing measure type; and
(c)(iii) comparing the representative timing measure length for each timing measure type to an exemplary length specified by a timing measure protocol defined by the industry standard as specific to each timing measure type.

26. A system for evaluating whether an interface between a host device and a target device complies with an industry standard, wherein a bus analyzer scans a communication trace transmitted between the host device and the target device and creates a log file recording logic transitions of signals lines contained in the communication trace, the system comprising:
a timing event analysis module analyzing the logic transitions to identify a timing measure present in the communication trace; and
means for evaluating the timing measure against a timing measure protocol specified by the industry standard.

27. The system of claim 26, wherein the timing event analysis module identifies the timing measure by detecting a timing measure condition in the communication trace, the timing measure condition being predefined by the timing measure protocol.

28. The system of claim 26, wherein the evaluating means comprises:
means for calculating a length, in time, of the timing measure from a start condition to an ending condition.

29. The system of claim 28, wherein the evaluating means comprises:
means for comparing the length to an exemplary length specified by the timing measure protocol to determine whether the timing measure complies with a specification of the industry standard.

30. The system of claim 26, wherein the industry standard is Small Computer System Interface.
